(19) United States
(12) Patent Application Publication
(10) Pub. No.: US 2015/0334065 A1
(43) Pub. Date: Nov. 19, 2015

(54) Method and System for Automated Social Communication Between Individual People

(71) Applicants: David Yan, Portola Valley, CA (US); Alena Yan, Portola Valley, CA (US); Donald Wisniewski, Bartlett, IL (US)

(72) Inventors: David Yan, Portola Valley, CA (US); Alena Yan, Portola Valley, CA (US); Donald Wisniewski, Bartlett, IL (US)

(21) Appl. No.: 14/713,531

(22) Filed: May 15, 2015

Related U.S. Application Data
(60) Provisional application No. 62/000,476, filed on May 19, 2014.

(51) Int. Cl. H04L 12/58; G06F 15/02; H04W 4/20; G10L 15/08; H04M 1/725; H04L 29/08; H04L 29/06

(52) U.S. Cl. CPC H04L 51/046; H04L 67/306; G06F 15/0225; H04L 65/403; G10L 15/08; H04M 1/72552; H04W 4/206

(57) ABSTRACT

A method according to a set of instructions stored on a memory of a computing device includes receiving, by a processor of the computing device, first and second user-profile information associated with a first and second user, respectively. The method further includes determining a match between the first and second users based on the first and second user-profile information. The method further includes establishing, in response to determining the match, a real time voice communication over a network between a first user device and a second user device. The method further includes sending or receiving information to the first user device and the second user device during the real time voice communication. First contact information associated with the first user device is not sent to the second user device. Second contact information associated with the second user device is not sent to the first user device.

### CROSS-REFERENCE TO RELATED PATENT APPLICATION

This non-provisional application claims priority to U.S. Provisional Application 62/000,476 filed on May 19, 2014, the entire contents of which are incorporated herein by reference.

### BACKGROUND

Many people today use electronic devices and media in their daily activities. For example, a typical person may have a smart phone and/or other electronic/computing devices. Smart phones and other types of electronic/computing devices may be used to place/receive phone calls, send/receive text messages, access the internet, create/edit documents, download/use software applications (often referred to as “apps” in the smart phone context), and many other functions. Software applications can be used on smart phones and other computing devices in an huge variety of ways, such as games, calendars, contact lists, etc. Software applications installed on computing devices may be able to interact with the hardware of a device to perform specific functions. For example, when a smart phone is used to place a telephone call, the smart phone may utilize a speaker and a microphone of the smart phone to allow the phone call. In another example, a computing device may utilize a display of the computing device to play a video media file.

### SUMMARY

An illustrative method according to a set of instructions stored on a memory of a computing device includes receiving, by a processor of the computing device, first user-profile information associated with a first user and second user-profile information associated with a second user. The method further includes determining, by the processor, a match between the first user and the second user based on the first user-profile information and the second user-profile information. The method further includes establishing, by the processor, in response to determining the match, a real time voice communication over a network between a first user device and a second user device. The method further includes sending or receiving information to the first user device and the second user device during the real time voice communication. First contact information associated with the first user device is not sent to the second user device. Second contact information associated with the second user device is not sent to the first user device.

An illustrative apparatus includes a memory, a processor operatively coupled to the memory, and a first set of instructions stored on the memory and configured to be executed by the processor. The processor is configured to receive first user-profile information associated with a first user and second user-profile information associated with a second user. The processor is further configured to determine a match between the first user and the second user based on the first user-profile information and the second user-profile information. The processor is further configured to establish, in response to the determined match, a real time voice communication over a network between a first user device and a second user device. The processor is further configured to send or receive information to the first user device and the second user device during the real time voice communication. First contact information associated with the first user device is not sent to the second user device. Second contact information associated with the second user device is not sent to the first user device.

An illustrative non-transitory computer readable medium has instructions stored thereon that, upon execution by a computing device, cause the computing device to perform operations. The instructions include instructions to receive, by a processor of the computing device, first user-profile information associated with a first user and second user-profile information associated with a second user. The instructions include instructions to determine, by the processor, a match between the first user and the second user based on the first user-profile information and the second user-profile information. The instructions include instructions to establish, by the processor, in response to determining the match, a real time voice communication over a network between a first user device and a second user device. The instructions include instructions to send or receive information to the first user device and the second user device during the real time voice communication. First contact information associated with the first user device is not sent to the second user device. Second contact information associated with the second user device is not sent to the first user device.

### BRIEF DESCRIPTION OF THE DRAWINGS

Illustrative embodiments will hereafter be described with reference to the accompanying drawings.

FIG. 1 is a representation of a graphical user interface (GUI) demonstrating a registration page in accordance with an illustrative embodiment.

FIG. 2 is a representation of a GUI demonstrating an introduction page in accordance with an illustrative embodiment.

FIG. 3 is a representation of a GUI demonstrating a rules page in accordance with an illustrative embodiment.

FIG. 4 is a representation of a GUI demonstrating a first profile information input page in accordance with an illustrative embodiment.

FIG. 5 is a representation of a GUI demonstrating a second profile information input page in accordance with an illustrative embodiment.

FIG. 6 is a representation of a GUI demonstrating a home page in accordance with an illustrative embodiment.

FIG. 7 is a representation of a GUI demonstrating an alternative view of a home page in accordance with an illustrative embodiment.

FIG. 8 is a representation of a GUI demonstrating a home page with a call being placed in accordance with an illustrative embodiment.

FIG. 9 is a representation of a GUI demonstrating a home page with a secondary menu in accordance with an illustrative embodiment.

FIG. 10 is a representation of a GUI demonstrating a home page receiving a call in accordance with an illustrative embodiment.

FIG. 11 is a representation of a GUI demonstrating an interactive current call information page in accordance with an illustrative embodiment.

FIG. 12 is a representation of a GUI demonstrating an interactive current call information page that requests more time added in accordance with an illustrative embodiment.

FIG. 13 is a representation of a GUI demonstrating an interactive current call information page with profile pictures displayed in accordance with an illustrative embodiment.

FIG. 14 is a representation of a GUI demonstrating an interactive current call information page with profile pictures and profile information displayed in accordance with an illustrative embodiment.

FIG. 15 is a representation of a GUI demonstrating a first feedback question page in accordance with an illustrative embodiment.

FIG. 16 is a representation of a GUI demonstrating a second feedback question page in accordance with an illustrative embodiment.

FIG. 17 is a representation of a GUI demonstrating a third feedback question page in accordance with an illustrative embodiment.

FIG. 18 is a representation of a GUI demonstrating a first call history information page in accordance with an illustrative embodiment.

FIG. 19 is a representation of a GUI demonstrating a second call history information page in accordance with an illustrative embodiment.

FIG. 20 is a representation of a GUI demonstrating a third call history information page in accordance with an illustrative embodiment.

FIG. 21 is a representation of a GUI demonstrating a referral contact information page in accordance with an illustrative embodiment.

FIG. 22 is a representation of a GUI demonstrating a contact list page in accordance with an illustrative embodiment.

FIG. 23 is a representation of a GUI demonstrating a virtual currency page in accordance with an illustrative embodiment.

FIG. 24 is a block diagram illustrating various computing and electronic storage devices that may be used in accordance with an illustrative embodiment.

FIG. 25 is a flow diagram illustrating a method of matching two users for a real time voice communication in accordance with an illustrative embodiment.

FIG. 26 is a flow diagram illustrating a method of receiving feedback about a user after a real time voice communication in accordance with an illustrative embodiment.

FIG. 27 is a flow diagram illustrating a method of processing feedback for a black list in accordance with an illustrative embodiment.

FIG. 28 is a flow diagram illustrating a method of releasing user-profile information between users in accordance with an illustrative embodiment.

FIG. 29 is a flow diagram illustrating a method of receiving contact information for a black list in accordance with an illustrative embodiment.

FIG. 30 is a flow diagram illustrating a method of using a virtual currency account in accordance with an illustrative embodiment.

FIG. 31 is a flow diagram illustrating a method of conversation recognition in accordance with an illustrative embodiment.

FIG. 32 is a flow diagram illustrating a method of manually reviewing a user profile in accordance with an illustrative embodiment.

### DETAILED DESCRIPTION

Described herein are illustrative embodiments for methods and systems that provide for connecting individuals through electronic devices. In an illustrative embodiment, a first user may download a software application to his or her electronic device, such as a mobile smart phone. Upon opening the software application (also referred to herein as an “app”), the first user can be prompted to specify various information about his or her self. Such information may include demographic information such as height, weight, sex, name, nickname, age, etc. Such information may also include other information, such as an e-mail address, phone number, interests, etc. The first user may also provide call time preference data about when they are available for real time voice communications (such as a phone call). The first user may also input demographic, interest, geolocation, occupation, sex, fitness level, or other user match preference data defining characteristics of a second user that the first user would like to be matched to and have a conversation with via a real time voice communication. In one illustrative embodiment, the system may only make certain preference data options available for free. Other preference data options can be unlocked in exchange for currency (virtual or real).

The system can automatically match the first user with the second user using the user match preference data of the first user (and the second user) to determine that the first and second users might enjoy speaking to one another. Accordingly, the first user can be offered an opportunity to place a call (also referred to herein as a real time voice communication) to the second user. If the second user accepts the call, the real time voice communication is established between the first and second users. The users can then speak to each other through their respective computing devices. Advantageously, the users can be matched and a call can be established between the users anonymously. In other words, the users can speak without knowing personal information about each other, such as phone numbers, name, address, interests, etc. In an alternative embodiment, a user may not be completely anonymous during a call. Accordingly, a phone number may not be sent or shared between two user devices, even though the two devices are engaged in a call together. For example, a first name or nickname of the first may be shared with the second user when they are engaged in a call. In another example, additional information about the first user may be released to the second user based on time spent on the call or an assent to release the information from the first user. The system may also facilitate conversation by sending possible conversation questions to the first user's computing device during the call.

During and/or after the real time voice communication (or call), the first and second users are invited by the system to provide feedback on the other user. For example, the system may provide a feedback question such as, “How funny was Claire?” In another example, the system may provide a feedback question such as, “Do you want to talk to Sam again?” Advantageously, the system can use the answers responsive to feedback questions to determine matches and establish real time voice communications for the users in the future. For example, if the user Claire gets high ratings from other users that indicate superior with and humor, Claire may be matched in the future with users who specify they like individuals that are funny and have a good sense of humor. In another example, if a user indicates that they would like to speak to Sam again, the system may prioritize connecting the user to Sam in a subsequent real time voice communication, pending Sam's availability. Such information may be stored as a part of a user's profile information and used when matching the user and or establishing calls for the user.

Accordingly, an illustrative embodiment may be a mobile app for smart phones such as an iPhone™ or Android™ smart phone that allows users to get acquainted with each other through anonymous or partially anonymous calls. The system can automatically identify a caller and a callee and initiate the call. The matches can be selected automatically by the system without specific user input of who a user wants to speak to. Accordingly, the users may be able to talk to and meet new people for conversation, discovery, and/or flirtation. The system may facilitate dating, social interactions, friendships, etc.

The systems and methods disclosed herein may advantageously address the pain of loneliness. For example, older generations of people may be very lonely and may have fallen out of touch with their peers or others that might enrich their lives. Other individuals may be interested in finding professional or hobby-driven contacts. For example, a user whose occupation involves event planning may wish to connect with other event planners to share tips, experience, etc. In another example, an origami enthusiast may wish to talk with and meet other paper folding fanatics.

Advantageously, the system can also accommodate different schedules. For example, a busy but lonely professional may have limited time to meet others because of demands from their job, taking care of children, other commitments, etc. Advantageously, the present system can accommodate a schedule by receiving, from the user, specified times and/or frequencies that the user would like to engage in calls. For example, a user may specify certain time ranges of specific days of the week during which the user would like to talk to other users (e.g., every Friday between 6 and 8 PM, central standard time). Further, the system may be able to track when the app is active on the user's computing device, such that calls are only initiated when the user is actively using the app. The system may also send an inquiry to the user through the app requesting whether the user would like to engage in a call at particular times. Further still, the system advantageously reduces the amount of time a user may spend looking at online profiles of others on dating websites or the like. Here, the system can automatically determine a match and connect the user on a call based on the user's previously entered profile information. Accordingly, the user does not need to repeatedly or tediously look through profiles and make speculative determinations about people they might be interested in based solely on a profile of another user. The system facilitates a user skipping the identification of potential partners and allows them to move ahead with the process of exploration and identification with another person.

Loneliness for individuals may be propagated by the demands of their job and the need to fulfill personal and family commitments. Putting pictures and personal histories on an online dating service profile may be personally embarrassing. Professionally or otherwise accomplished individuals may be concerned about the legitimacy of persons who reviews these profiles. The actions of a multitude of Internet websites may examine a user's pictures and profiles and use facial matching software with identified professional profiles on such services as Linked In™ or Facebook™ to scrape data for defamatory and/or possibly criminal activity. Individuals may not have the time to read profiles online, many of which are fictitious or spend hours at clubs or bars in the hope that a random meeting may connect them with a compatible partner.

Dating websites may facilitate social interaction between individuals who have never met, but rejection may occur unnecessarily because of incidental factors such as an unflattering photograph, or a writing style which causes an immediate rejection. If the individuals had spoken with the person in a real time voice communication, they might have continued the social interaction. Accordingly, without the present system and methods, people may be ignored because of superficial and/or cosmetic reasons. Advantageously, individuals may no longer miss out on successful social connections in this way, leading to improved satisfaction among users of the system and methods.

Advantageously, the system may not immediately display an image of the second user to the first user. Hence, the users can start to interact and get to know one another without prejudging each other based on physical appearance or other information that may have been listed in a user profile. As such, a user may not as easily mislead other users with a picture or photo that is not representative of their current appearance (or with a picture or photo of an entirely different person). In other words, the system allows users to communicate before reading profiles and viewing photos. Advantageously, more users may also have meaningful interactions because the system automatically generates matches. In this way, there are not certain users who are overlooked by other users and never get a match. Such a situation can improve satisfaction of users with the app. Users may more favorably view a photo or profile information if they already have a good impression of the other user from the real time voice communication.

Further, even though the system may not utilize vast profiles that a user must search and read through to find potential matches, the system may still accommodate the preferences of its users when determining a match. For example, a first user may enter preference data to be included in the first user-profile information that is used in determining a match. Such information may include desired characteristics such as age, sex, interests, etc. of who the first user would like to meet.

The system may incorporate a currency or virtual currency aspect. For example, a call may be free at first. If the users are enjoying the call, a user may pay for additional time for the users to interact. The payment may be with a virtual currency, real currency, or a virtual currency that is tied to or can be purchased with real currency. In other illustrative embodiments, the system may also deduct currency for other actions, such as declining a call or ending a call before a predetermined time has elapsed. In this way, users may be incentivized to interact more with the user they have been matched with.

After a call or during the call, the users may be engaged for feedback about the other user. The users may earn currency for answering questions about another user. The answers may also be stored in the user profiles and used for subsequent matching and calls established. For example, a first user may be asked feedback questions about a second user. The answers may be stored in the first user's profile and used to identify trends about the types of people the first user likes. The answers may also be stored in the second user's profile and used to identify the type of person the second user is or determine things that other users like or do not like about the second user. The more feedback that is gathered regarding different users, the more trend data can emerge, and the more the information can be used to determine matches and establish calls. In other words, the system gradually forms a portrait of its users. If the users give high ratings on each other or expressly assent to talking with each other again, such data may be used to subsequently match them in the future and/or establish a call between them.

The system may also receive referral contact information from a user device. The referral contact information may be directly entered by a user into the app, or the contact information could be accessed through a user device's contact list. If a first user refers another individual, the first user may receive currency. If the other individual signs up for the service and becomes a second user, the first user may receive additional currency. If the second user enters a predetermined amount of user-profile information, the first user may receive still additional currency. The second user may also receive currency for completing part or all of presented user-profile questions. The first user may also receive currency if the second user participates in a real time voice communication with another user.

Another way the system may add information to a user-profile is through detecting questions and answers during the calls a user is on. A user may earn currency for answering a question. Voice recognition software may be utilized to determine questions and/or answers spoken by a user. In another example, the system may send questions to the user's computing device. The user may answer on the computing device, and the answer is sent back to the system and included in the user-profile information. In one embodiment, the answer may also be sent to the second user's computing device. In this way, the users may interact with each other based on conversation questions generated by the system and the system can collect more information for the user-profiles. Such information can be used in subsequent matching and call establishment for the users. Similarly, the system may be able to determine if certain questions/answers or certain types of questions/answers work better for facilitating conversation by comparing the questions presented to the users feedback ratings after the conversation. Similarly, the system may also be able to track information on what questions and/or types of questions are actually answered by users while on a call. Questions sent to a user device may be open ended. An open ended question may be answered by entering text via the user's computing device, or an open ended question may be meant merely to stimulate conversation and no answer is entered at all. Other types of questions may include discreet answer fields/choices. For example, questions may be yes/no, multiple choice, select from a list, etc. Such questions sent to a mobile device may be configured so that the user sees the various choices/fields and can answer accordingly using the computing device.

Advantageously, a user can connect with another user without having to express interest in matching with the user first. Accordingly, this also saves the user from a potential rejection before the users have interacted. This is possible because the system automatically determines matches and establishes calls, often with two users who know nothing about each other before the call. Users can also advantageously avoid having a public profile with significant amounts of personal information.

In another embodiment, the system may utilize a black list feature. In one example, if a first user gives a feedback answer that the first user does not want to talk to a second user again, the second user may be added to the first user's black list. A user on the black list cannot be matched to the first user (and similarly cannot be put on a call with the first user).

Advantageously, users may also be able to utilize a black list to maintain anonymity while utilizing the system. The user may select certain users (using any of a name, phone number, birthdate, etc.) to be on the black list. For example, a user may not want to be inadvertently matched with a coworker. Accordingly, the user may enter contact information of colleagues to ensure that they are on the black list. The system, when determining a match, does not match the user with a profile that has information related to the contacts on the black list. In one embodiment, the system may be able to access a user's contact list through an app on a computing device. In this way, the user may easily select some or all of the user's contacts to be added to the black list. In another embodiment, the system may access a user's social network accounts to determine friends or other social networking profiles that the user has a relationship with. In this way, the user may also specify some or all of their social networking contacts to be included on the black list. Social networks may include any type of social network, such as LinkedIn™, Facebook™, Twitter™, Instagram™, WhatsApp™, Snapchat™ Instagram™, or any other social network. The system can also automatically update to expand the black list if a user's social network or contact list expands over time. In one embodiment, the system may make an exception on blacklisting someone if the user has previously connected to that person using the methods or systems disclosed herein. In other words, if a person is matched through the present system and gets to know them, the user may add them to a social network. Accordingly, the user may not wish the other person to be added to the black list since both parties are already aware of each other's use of the system. In another embodiment, the user may wish the other person to be on the black list, since the user now has an alternative means to communicate with the person (such as the social network). In another embodiment, any referrals that a user specifies or invites may also be added to the black list, since the user presumably already has ways to connect with the invited individuals.

Advantageously, the system and methods described herein facilitate interactions between those looking for human interaction. The system can facilitate conversations with conversation questions. The system can help remove a psychological barrier to starting a conversation with a stranger.

When a potential user receives a referral or other form of invitation, the invitation may include a universal resource identifier (URI) that navigates a computing device to a webpage, app store, or other location. The app store, webpage, etc. can include instructions for downloading or otherwise procuring the app. After downloading the application or otherwise procuring it, the app can be opened and utilized by a user on a user device.

Some references generally directed toward social interaction include U.S. Pat. No. 7,907,149 to Daum (2011), U.S. Pat. No. 7,203,674 to Cohen (2007), and U.S. Pat. No. 6,735,568 to Buckwalter et al. (2004). However, the references fail to encompass the advantages of the methods and systems disclosed herein. As just one illustrative example, the references do not offer an easy way to start conversations with others without the hassle of creating or perusing through lengthy profiles, and no waiting to find out if any of you hopeful matches have opted to be interested in you as well. The embodiments disclosed herein also, as one additional illustrative example, cut down on fake profiles that are common on social interaction platforms, because the users have to talk to someone in a real time communication before getting any information about another person. The systems and methods disclosed herein offer many other advantages.

The methods and systems disclosed herein are directed to overcome some of the past deficiencies in these social communication sites by taking an active role in gathering profile information of users, intelligently associating users by their interests, proactively making connections between users, during the interaction between the users in real time performing complex semantic analysis of the voice and text data exchanged between the users in order to understand the satisfaction level to continue or discontinue the connection, to making a future connections, and finally protecting the active information obtained to safeguard users.

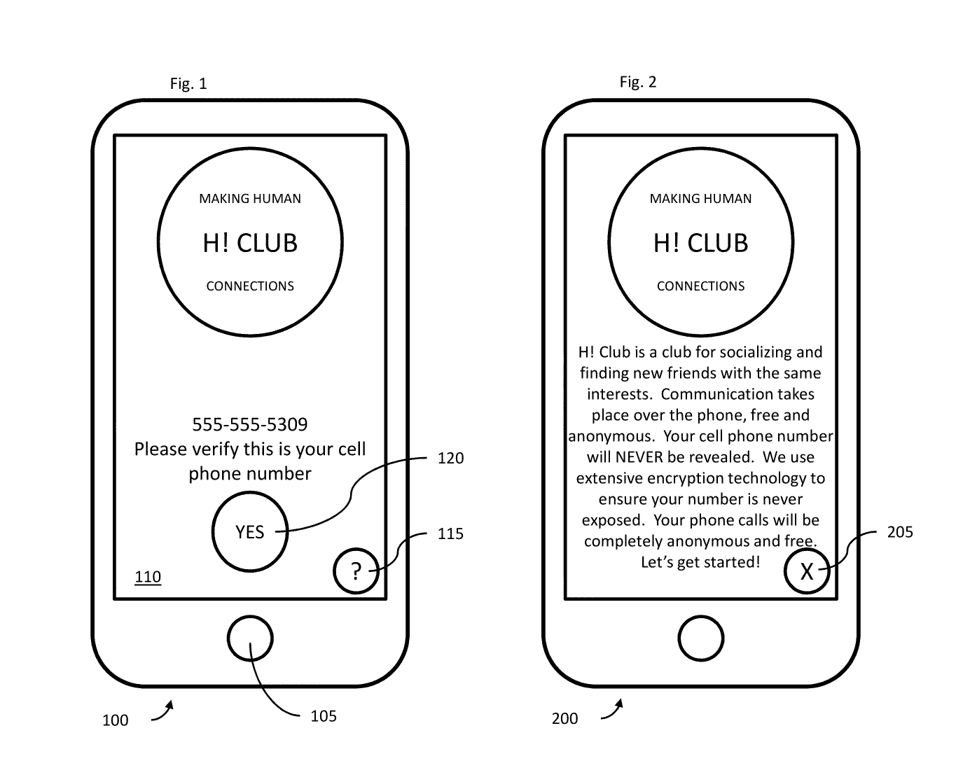

FIG. 1 is a representation of a graphical user interface (GUI) 100 demonstrating a registration page in accordance with an illustrative embodiment. In alternative embodiments, fewer, additional, and/or different components may be displayed on the GUI. The GUI 100 shows a smart phone with a screen 110 and a button 105. The screen 110 is touch screen such that a user may interact with what is shown on the screen 110. The user may also interact with an app using the button 105.

The GUI 100 includes a yes button 120 and a question button 115. In this embodiment, the app has automatically identified the phone number of the smart phone for the first user that is signing up for the service. If the phone number is correct, the user can press the yes button 120. If not, or the user has other questions, the user can press the question button 115. The user can, on other GUIs not shown here, manually enter their phone number or other contact information. For example, in an alternative embodiment, the user may be using a personal computer that does not have a phone number associated with it. Accordingly, the system may ask for a confirmation email, confirmation email verification, and/or other sorts of confirmation steps.

FIG. 2 is a representation of a GUI 200 demonstrating an introduction page in accordance with an illustrative embodiment. In alternative embodiments, fewer, additional, and/or different components may be displayed on the GUI. After confirming contact information in the GUI 100, the GUI 200 shows an introduction of the methods and systems disclosed herein. The GUI mentions that the user's phone number will never be revealed to other users. In alternative embodiments, the system may be using information other than a phone number that will not be revealed, such as an email address, internet protocol (IP) address, social security number, username, etc. In another alternative embodiment, the system may be configured to share contact or other information with the assent of the user. The GUI 200 includes a close button 205. If the user presses the close button 205, the GUI 200 will close and the user can move on with the process of registering.

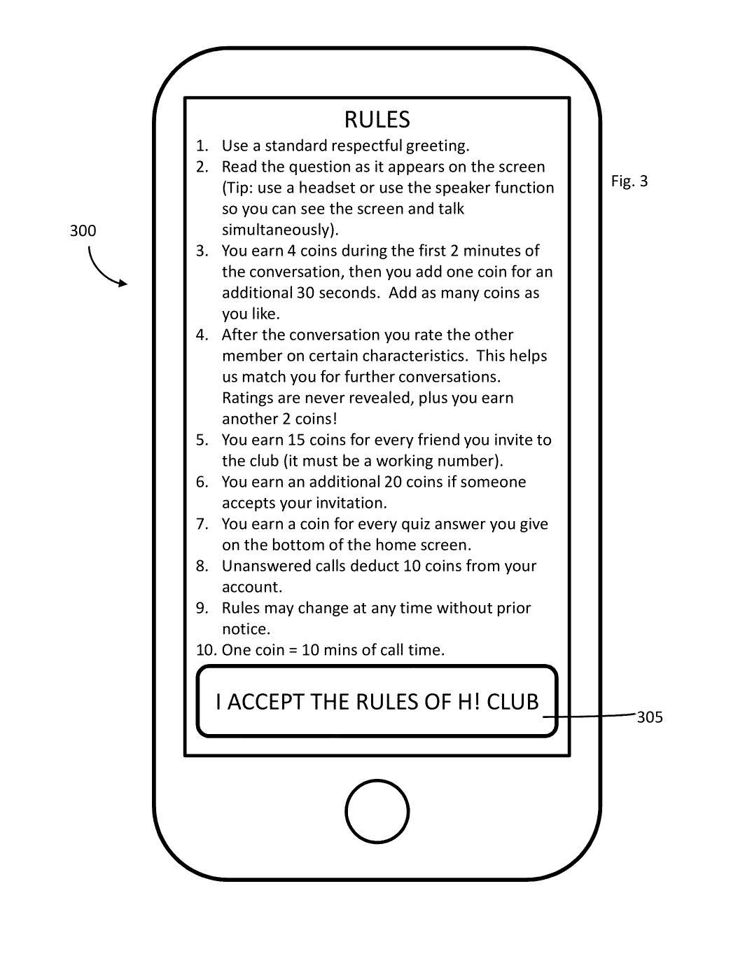

FIG. 3 is a representation of a GUI 300 demonstrating a rules page in accordance with an illustrative embodiment. In alternative embodiments, fewer, additional, and/or different components may be displayed on the GUI. The GUI 300 shows various rules for the system and methods disclosed herein. The GUI 300 briefly details how the app works and how a user should behave on the app. In the present embodiment, the virtual and/or incentive currency is referred to as coins.

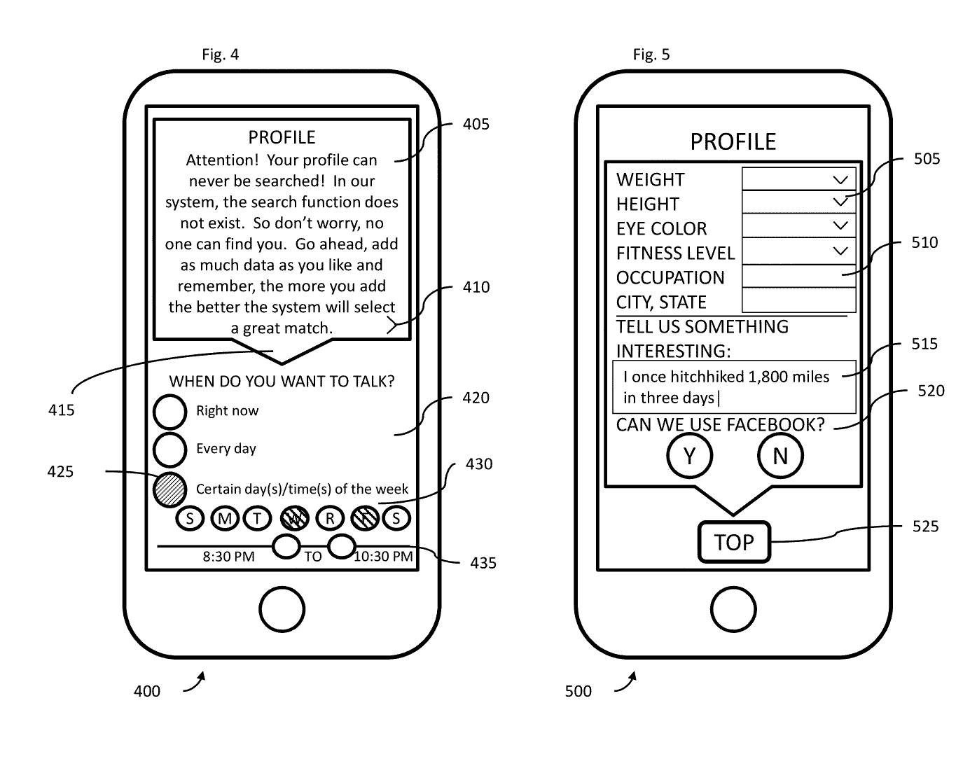

FIG. 4 is a representation of a GUI 400 demonstrating a first profile information input page in accordance with an illustrative embodiment. In alternative embodiments, fewer, additional, and/or different components may be displayed on the GUI. The GUI 400 shows a profile instruction dialog 405. The dialog 405 includes an arrow 410. The arrow 410 may be used to advance to a next GUI screen.

A notch 415 indicates that the user may scroll down to another part of the current page, such as the part shown in FIG. 5. On the GUI 400, the user can enter information at a question 420 about when the user wants to talk (call time preference data). For example, the question 420 asks when a user might want to talk. The user may select right now, every day (and the user may further specify times of day as shown with a sliding bar 435), certain times of the week as selected by a selection 425, once a month (user could specify what day/time), once a week (user could specify what day/time), or any other selection of when a user might want to talk. A day selection field 430 is also shown. Here, the user has selected Wednesday and Friday between 8:30 PM and 10:30 PM as desirable times to talk to matches. The sliding bar 435 allows a user to drag circles to indicate a window of time when the user is willing to participate in a real time voice communication.

FIG. 5 is a representation of a GUI 500 demonstrating a second profile information input page in accordance with an illustrative embodiment. In alternative embodiments, fewer, additional, and/or different components may be displayed on the GUI. The GUI 500 shows more profile entry. An arrow 505 may be selected to reveal a dropdown menu and may be used for user-profile inquiries that have a limited number of possible answers. In another inquiry 510, the entry may be freeform as the user can enter whatever they like for occupation. Similarly, the user may be able to type whatever they want in the an entry box 515. At an inquiry 520, the user may indicate whether the system may procure additional user-profile information from a social network such as Facebook™. The GUI 500 also includes a top button 525. If the user selects the top button 525, the GUI will return to a top screen such as the one shown in FIG. 4.

Although only two profile entry screens were shown (FIGS. 4 and 5), many more are possible and may be scrolled to in between the display of the GUI 400 and the GUI 500. For example, the app may request who a user wants to talk to (e.g., women, men, other, does not matter). The app may also request what age(s) the user would like to speak with. The app may request particular contacts (manually entered, from contact list on phone, from Facebook, etc.) that the user would like to be on a black list and not allowed to be matched with the user. The app may request additional data such as a nickname to be displayed to other users, sex, interests of the user, age, height, weight, a photo, etc. The system may get some of the information, such as a photo, from a social networking site (e.g., Facebook™). The system may also utilize a social networking or other external profile to verify information entered on the user account. This may help reduce fraud and/or fake accounts. Additionally, the user may be able to specify particular user-profile information that can be shared by the user with another user during a real time voice communication. The system may request other information in other embodiments, such as hair color, eye color, fitness level, etc.

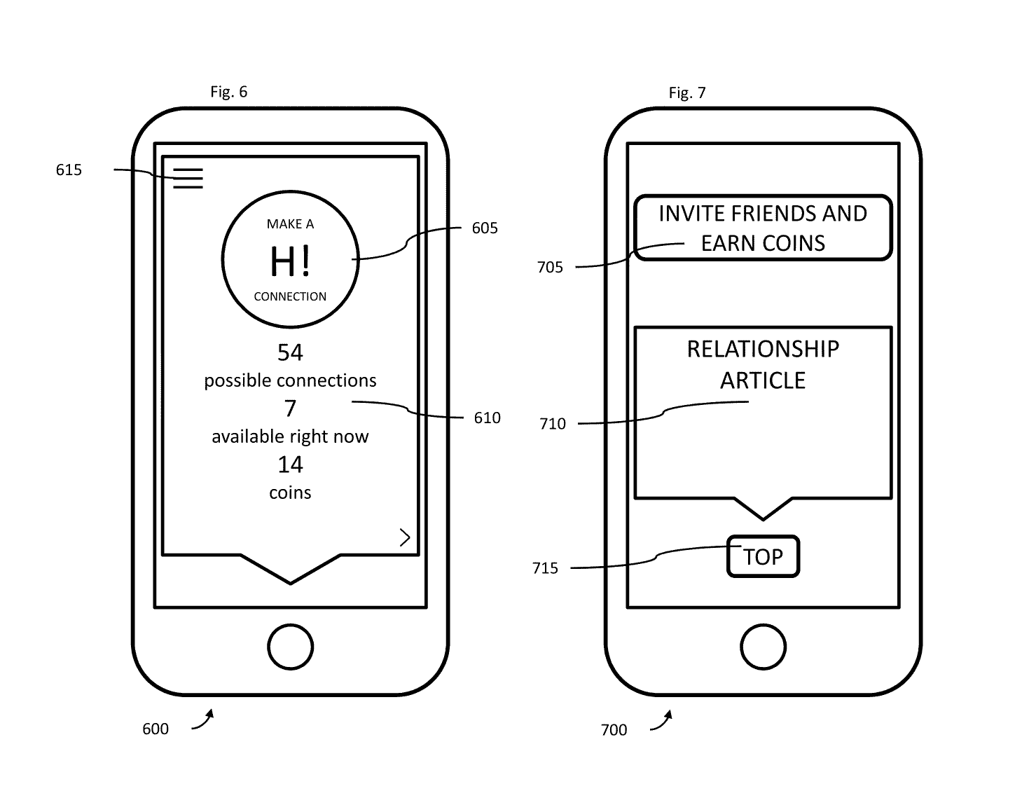

FIG. 6 is a representation of a GUI 600 demonstrating a home page in accordance with an illustrative embodiment. In alternative embodiments, fewer, additional, and/or different components may be displayed on the GUI. The GUI 600 includes a menu button 615. If a user selects the menu button 615, a secondary menu may be displayed as shown in FIG. 9.

The GUI 600 also includes a connect button 605. If a user pushes the connect button 605, the system will automatically match the user with a second user according to the systems and methods disclosed herein. In an alternative embodiment, the app may receive a call even if the user has not pressed the connect button 605. Information 610 indicates various data to the user. For example, the user has 54 possible connections, 7 of whom are available for talking now. The user also has 14 coins (or currency). If the user selects the connect button 605, a call may be through the internet (such as voice over internet protocol, or VoIP), or some other way to perform a call such as a video call through Skype™ or another video calling service. The system may thereby avoid placing a call through standard phone lines and prevent a call from being shown in the call log of a smart phone. Further, this may protect the users from inadvertently sharing contact information with one another, increasing anonymity and security of personal information. If no matches are found, the system may ask the user to try again later.

FIG. 7 is a representation of a GUI 700 demonstrating an alternative view of a home page in accordance with an illustrative embodiment. In alternative embodiments, fewer, additional, and/or different components may be displayed on the GUI. A user may scroll vertically from the GUI 600 shown in FIG. 6 to view the GUI 700. Accordingly, the GUI 700 includes a top button 715 that allows a user to navigate back to the top of the page whenever they have scrolled down. Although only the GUIs 600 and 700 are shown, the home page may include many more GUIs that can be scrolled to. The GUI 700 also includes an invite friends button 705 and a relationship article 710. The invite friends button 705 may be pushed to invite friends to use the app. The relationship article may inform users about various relationship topics, research, etc. that a user may find relevant.

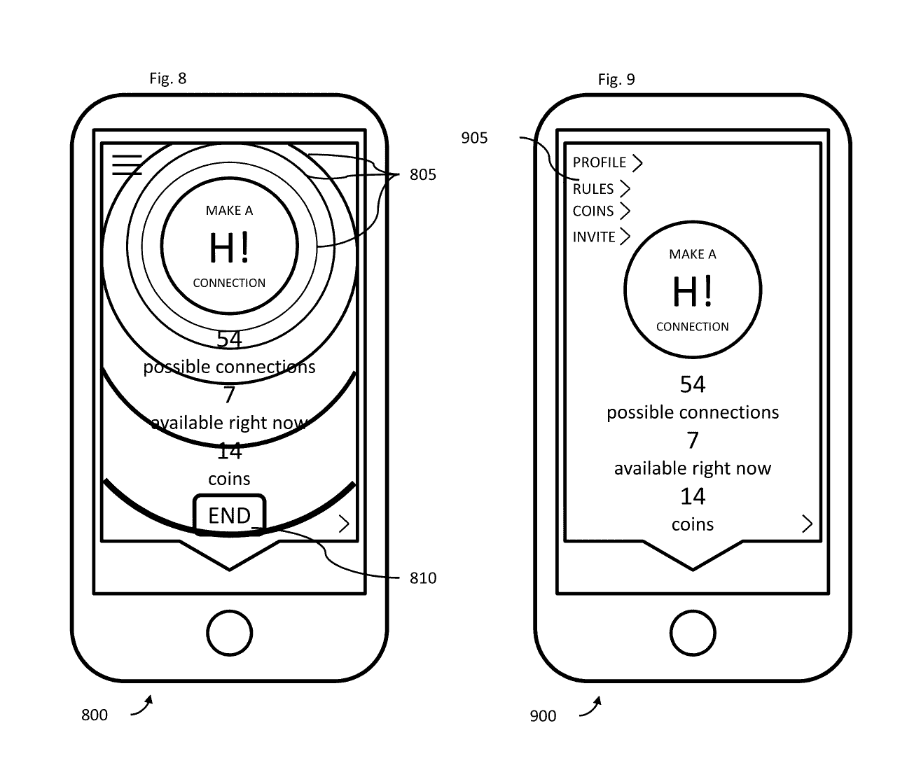

FIG. 8 is a representation of a GUI 800 demonstrating a home page with a call being placed in accordance with an illustrative embodiment. In alternative embodiments, fewer, additional, and/or different components may be displayed on the GUI. The GUI 800 shows an outgoing call screen that the user might see after pressing the connect button 605 of FIG. 6. The GUI 800 includes concentric circles 805 that move out from the connect button and become increasingly larger. The GUI 800 also includes an end button 810 that may be pressed to stop the outgoing call before it is answered.

FIG. 9 is a representation of a GUI 900 demonstrating a home page with a secondary menu in accordance with an illustrative embodiment. In alternative embodiments, fewer, additional, and/or different components may be displayed on the GUI. The GUI 900 shows the secondary menu 905 including the choices profile, rules, coins, and invite. If profile is selected, the user may update their profile. If rules is selected, the user may review the rules. If coins is selected, the user may purchase coins, view coin expenditure history, and/or view coin earning history. If invite is selected, the user may invite additional people to use the app.

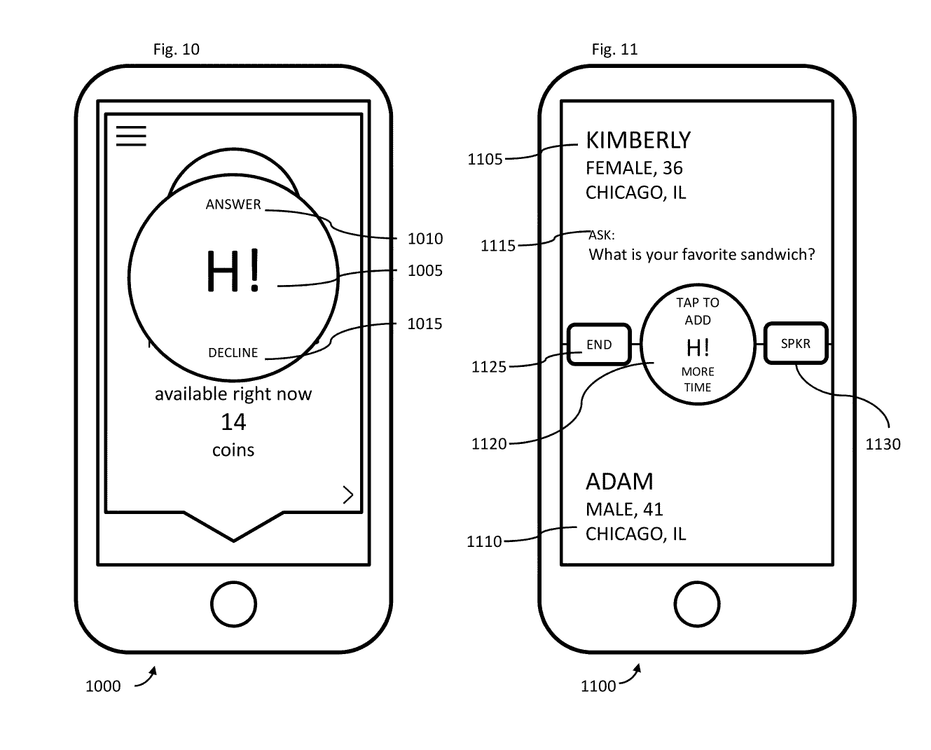

FIG. 10 is a representation of a GUI 1000 demonstrating a home page receiving a call in accordance with an illustrative embodiment. In alternative embodiments, fewer, additional, and/or different components may be displayed on the GUI. The GUI 1000 shows an incoming call screen and an incoming call dialog 1005. The GUI 1000 shows an answer button 1010 that, if selected, causes the user device to accept the call and begin a real time voice communication. The GUI 100 also shows a call decline button 1015 that, if selected, causes the user device to decline the call.

FIG. 11 is a representation of a GUI 1100 demonstrating an interactive current call information page in accordance with an illustrative embodiment. In alternative embodiments, fewer, additional, and/or different components may be displayed on the GUI. The GUI 1100 includes a first user name and information 1110. The GUI 1100 also includes a second user name and information 1105. In this embodiment, this is the view on the user device of Adam, though in an alternative embodiment he may have his information at the top of the GUI 1100.

The GUI 1100 also shows a conversation question 1115 sent from the system. The GUI 1100 also includes an end button 1125 that, if selected, can end the real time voice communication. The GUI 1100 also includes a speaker button 1130 that, if selected, may activate a speaker on the user device so that the user may more easily interact with and see the GUI 1100. The GUI 1100 also includes the add more time button 1120. The add more time button 1120 may be selected if a free portion of a call is running out and the user wants to redeem a currency (coin) for more time to talk with the other user. Such a system incentivizes a user to stay on at least long enough for the free portion of the call (and possible earn some incentive currency). After the first predetermined portion, a user may then have to pay the currency to keep talking to the second user after they have started liking talking to the second user. The second user may also pay to extend a call. If the second user extends the call, an indication of that extension may be displayed on the first user's device. This may be nice for the first user to see, as it serves as a compliment from the second user that the second user desires to keep talking. If the first user was not receptive and chose to end the call before the currency was redeemed, the second user could be refunded of the currency.

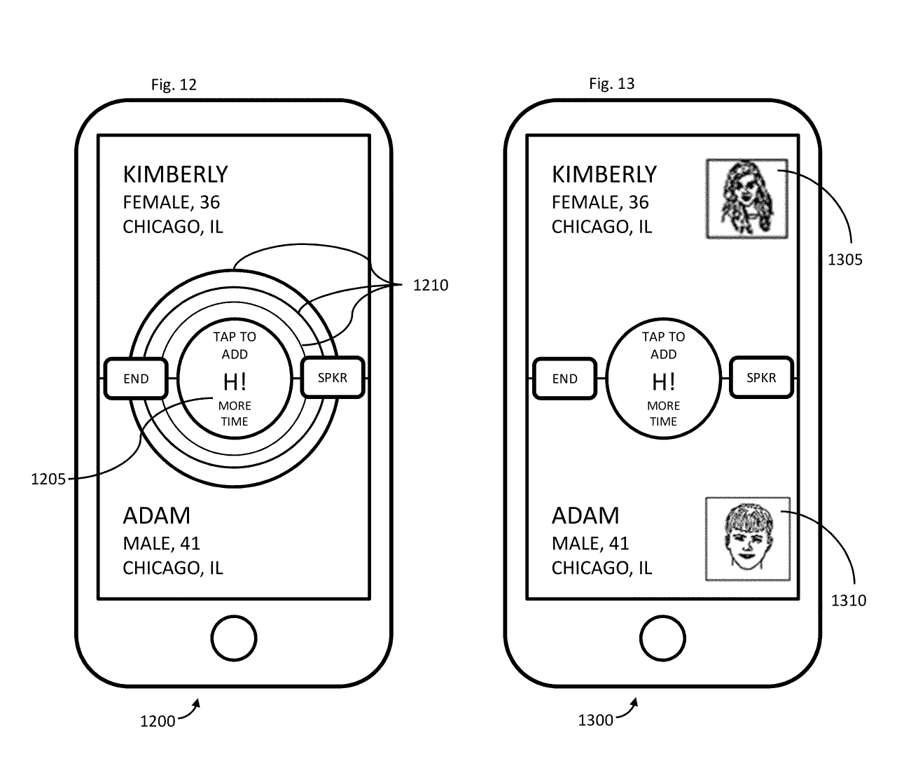

FIG. 12 is a representation of a GUI 1200 demonstrating an interactive current call information page that requests more time added in accordance with an illustrative embodiment. In alternative embodiments, fewer, additional, and/or different components may be displayed on the GUI. The GUI 1200 shows an add more time button 1205. Concentric circles 1210 may move outward from the add more time button 1205. The concentric circles 1210 may be displayed when the users are about to run out of time to talk, thus prompting the user to add more time for the conversation.

FIG. 13 is a representation of a GUI 1300 demonstrating an interactive current call information page with profile pictures displayed in accordance with an illustrative embodiment. In alternative embodiments, fewer, additional, and/or different components may be displayed on the GUI. The GUI 1300 includes profile pictures 1305 and 1310. The profile pictures 1305 and 1310 may be displayed based on a assent from the users to display them. In another embodiment, the profile pictures 1305 and 1310 may be displayed after the users have been in the real time voice communication for a predetermined amount of time. In another embodiment, a profile picture of a first user may only be displayed to the second user if the second user uses currency to reveal it.

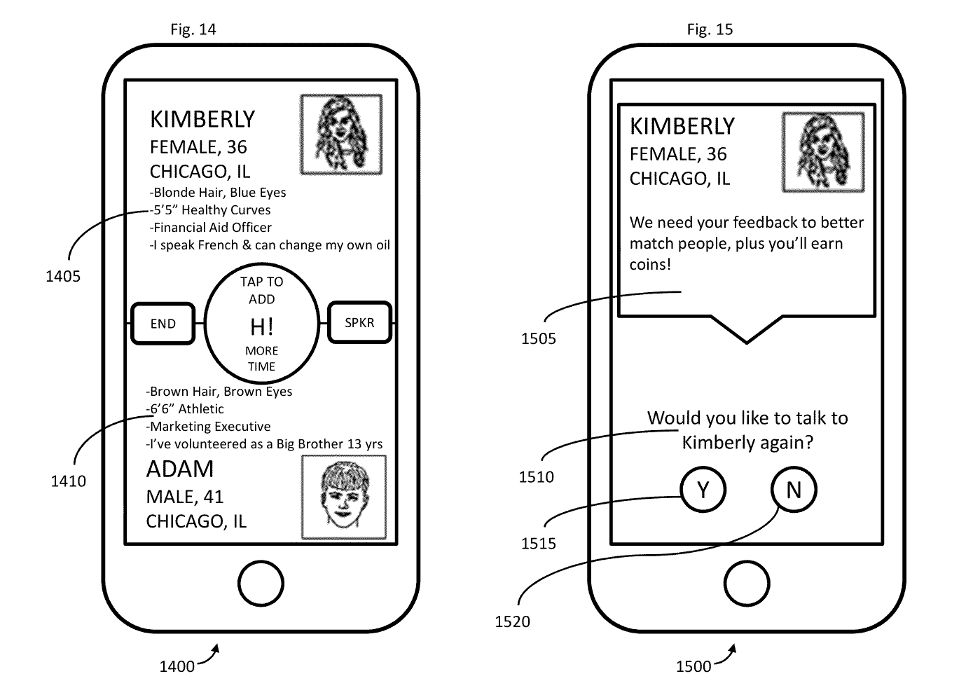

FIG. 14 is a representation of a GUI 1400 demonstrating an interactive current call information page with profile pictures and profile information displayed in accordance with an illustrative embodiment. In alternative embodiments, fewer, additional, and/or different components may be displayed on the GUI. The GUI 1400 includes user-profile information 1405 and 1410. The user-profile information 1405 and 1410 may be displayed based on a assent from the users to display it. In an alternative embodiment, the users may assent to certain portions of their user-profile information being displayed, such that a user can control when and what information is shared. In another embodiment, the user-profile information 1405 and 1410 may be displayed after the users have been in the real time voice communication for a predetermined amount of time. In another embodiment, user-profile information of a first user may only be displayed to the second user if the second user uses currency to reveal it. In another alternative embodiment, user-profile information and/or a user photo may only be displayed after a predetermined number of calls between the same two users. That is, for example, a user may only see a photo of another user on their third call together.

In other illustrative embodiments, a GUI during a call may show various other interactive information that results from the system sending and receiving information to and from a first user device and a second user device. For example, the system may facilitate conversation questions and answers to be input through a GUI. The system may allow for real time ratings and feedback of a user during a call input through a GUI. Touches to a GUI of a first user device may be seen in real time by the second user device so that the call is even more interactive. In this way, users may see each other's answers to conversation questions and see user-profile information shared with each other. Such interactivity enhances the conversation and connection between the callers. A user may also be prompted with feedback questions, such as “Would you like to continue this conversation?” If so, the user may be prompted to spend currency.

In another alternative embodiment, a user may be able to select a mood before a call. A reminder may be sent to the user device about a scheduled call or call interval time. The reminder may include a request for the user's mood. The mood may be used as part of the user-profile information in selecting the match for the user.

In another alternative embodiment, the system can recognize conversations by converting speech to text. The system can recognize questions and answers, and use this information to form a dossier about each user. Such a dossier may not be visible to users, but the system may store this information as user-profile information and use it for the best selection of matches and for other smart actions. The system may semantically analyze the questions, answers, and conversation to lead the conversation, generating particular questions which may appear on the screen or may be acoustically announced during conversation. The more a user participates in conversations, the more the system will know about this user. This can result in better matching and more stimulating conversations.

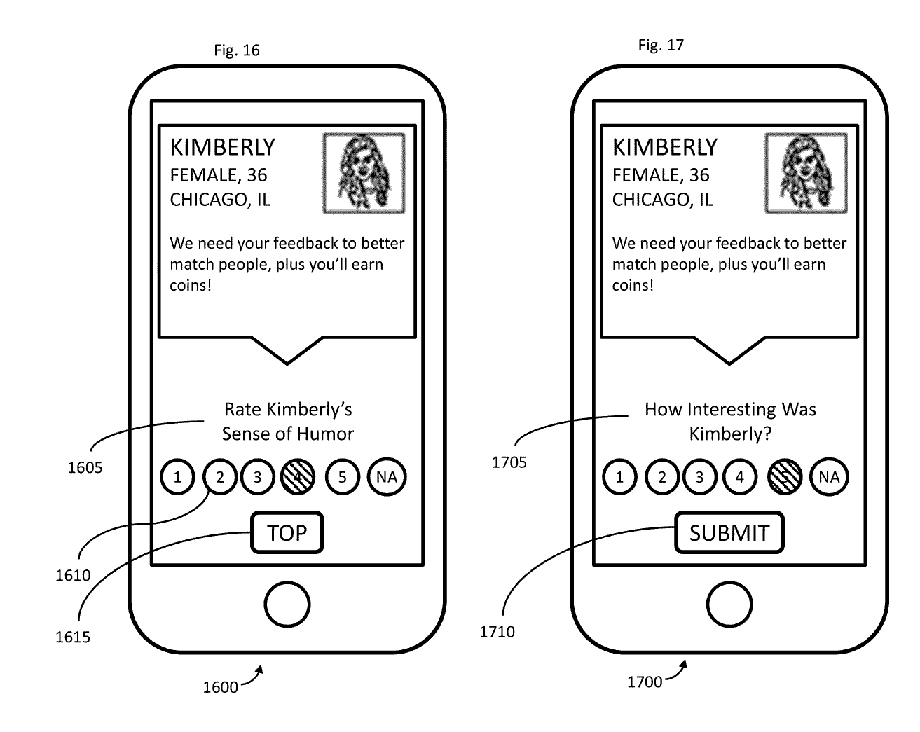

FIG. 15 is a representation of a GUI 1500 demonstrating a first feedback question page in accordance with an illustrative embodiment. In alternative embodiments, fewer, additional, and/or different components may be displayed on the GUI. The GUI 1500 shows a feedback instruction 1505 and a feedback question 1510. The user can mark yes 1515 or no 1520 about whether they would like to speak to Kimberly again. A user may scroll vertically to view other feedback questions, such as those shown in FIGS. 16 and 17.

FIG. 16 is a representation of a GUI 1600 demonstrating a second feedback question page in accordance with an illustrative embodiment. In alternative embodiments, fewer, additional, and/or different components may be displayed on the GUI. The GUI 1600 shows a question 1605, and answer choices 1610. The answer choices 1610 allow a user to answer on a scale of 1 to 5 (or N/A if the user cannot answer for some reason). Here the number 4 is shown as selected. The GUI 1600 also shows a top button 1615 that, if selected, may return the user to the GUI 1500.

FIG. 17 is a representation of a GUI 1700 demonstrating a third feedback question page in accordance with an illustrative embodiment. In alternative embodiments, fewer, additional, and/or different components may be displayed on the GUI. The GUI 1700 shows a question 1705. The GUI 1700 also includes a submit button 1710 that allows a user to submit their feedback answers.

In alternative embodiment, fewer or more feedback questions may be vertically scrolled to similar to FIGS. 15-17. For example, the system may further seek feedback such as: give an overall assessment of the other user; intelligence; spontaneity; morality; appearance (if there was a photograph).

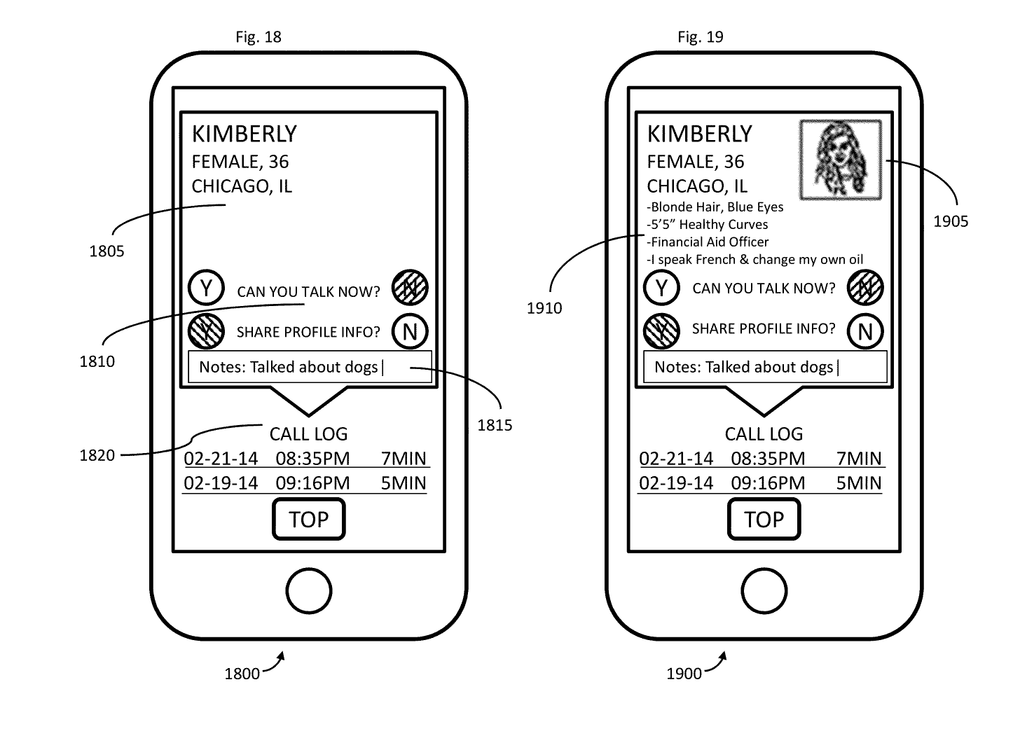

FIG. 18 is a representation of a GUI 1800 demonstrating a first call history information page in accordance with an illustrative embodiment. In alternative embodiments, fewer, additional, and/or different components may be displayed on the GUI. The GUI 1800 may be accessed, for example, by a horizontal swipe from the GUI 600 or pressing the arrow on the lower right of the GUI 600. The GUI 1800 may also be accessed in other ways.

The GUI 1800 includes a call history entry 1805 for Kimberly. The call history entry includes questions 1810. The questions 1810 include whether a user can talk now and whether to share user-profile information with Kimberly. In one embodiment, if yes is selected to share information with Kimberly, user-profile information will show up in Kimberly's call history (similar to FIG. 19 element 1910). In another embodiment, the user-profile information may only show up during a call with Kimberly.

If the ‘can you talk’ question is set to no, a call between Kimberly and the user will not take place. If yes is selected, Kimberly may be connected to the user on a call. In one embodiment, Kimberly will be notified that the user is available and will have the opportunity to initiate a call. In another embodiment, the system may recognize that the user is available, and Kimberly and the user may be automatically matched by virtue of their both being available at the same time and their desire to start a call. In one embodiment, one or both of the questions 1810 are only displayed if the user has indicated a desire to talk to Kimberly again.

The GUI 1800 also includes a notes 1815 field where a user can write anything they would like to recall about Kimberly. The GUI 1800 also includes a call log 1820 regarding each time that the user has talked to Kimberly. In other embodiments, the GUI 1800 may include additional or different information. For example, the GUI 1800 may show feedback data from Kimberly about the user, feedback data about Kimberly, more conversation notes such as questions discussed and their respective answers, audio notes of or about the conversation, etc. The GUI 1800 may also organize the call history based on different factors. The GUI 1800 can be vertically scrolled to other entries in the call history with other users. The users may be organized such that most recent calls are on top. In another embodiment, users may be organized based on feedback ratings from the user. For example, the highest overall ratings or highest appearance may be at the top.

FIG. 19 is a representation of a GUI 1900 demonstrating a second call history information page in accordance with an illustrative embodiment. In alternative embodiments, fewer, additional, and/or different components may be displayed on the GUI. The GUI 1900 relating to Kimberly is similar to the GUI 1800, except Kimberly's photo 1905 and user-profile information 1910 are showing. Here, Kimberly has assented to her photo 1905 and user-profile information 1910 being displayed to the user after or during a call with the user.

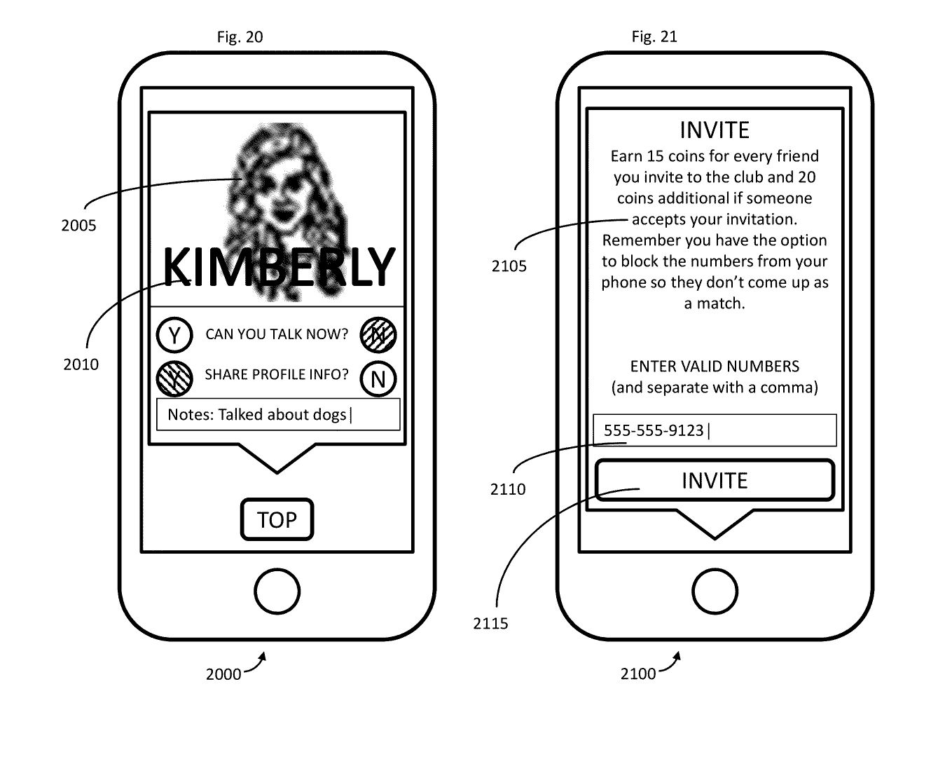

FIG. 20 is a representation of a GUI 2000 demonstrating a third call history information page in accordance with an illustrative embodiment. In alternative embodiments, fewer, additional, and/or different components may be displayed on the GUI. The GUI 2000 shows an alternative embodiment of the GUIs 1800 and 1900. Here a photo 2005 and name 2010 of Kimberly are prominently displayed for a more visual effect.

FIG. 21 is a representation of a GUI 2100 demonstrating a referral contact information page in accordance with an illustrative embodiment. In alternative embodiments, fewer, additional, and/or different components may be displayed on the GUI. The GUI 2100 may be navigated to if the user selects the invite friends button 705 from FIG. 7. The GUI includes an invite dialog 2105. The GUI 2100 also includes a contact number entry field 2110, where the user may enter the phone number of a contact to be invited. In an alternate embodiment, information other than a phone number may be used, such as an email address. The GUI 2100 also includes an invite button 2115 that, if selected, sends an invite to the contact whose information is entered into the contact number entry field 2110.

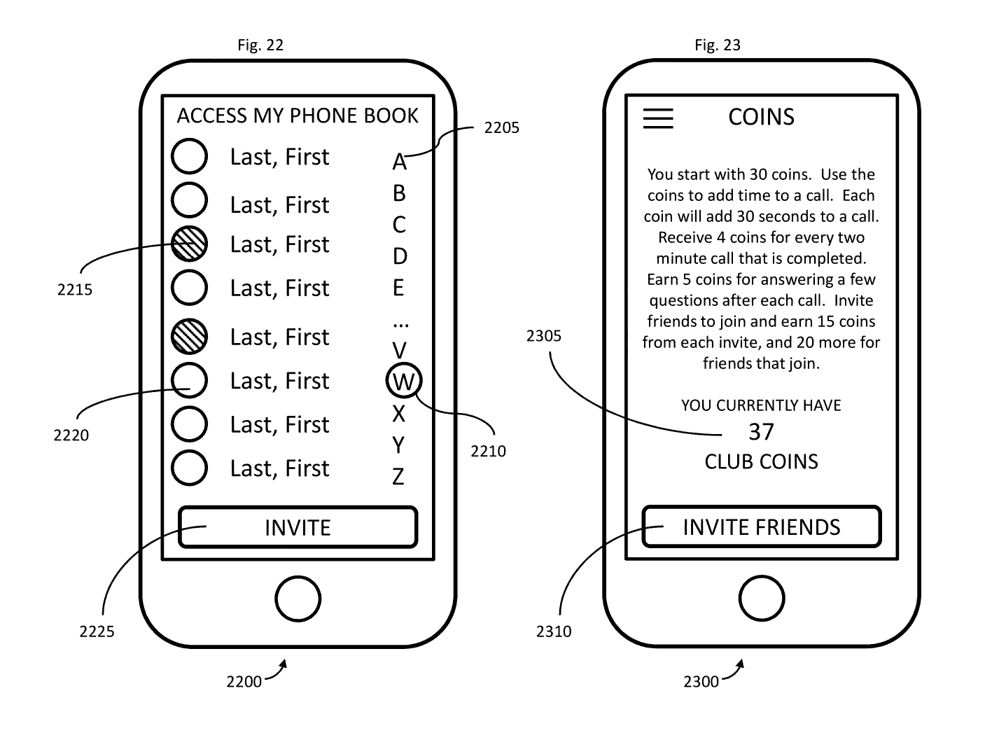

FIG. 22 is a representation of a GUI 2200 demonstrating a contact list page in accordance with an illustrative embodiment. In alternative embodiments, fewer, additional, and/or different components may be displayed on the GUI. If the GUI 2100 is scrolled vertically, the GUI 2200 is shown. The GUI 2200 includes a navigation alphabet 2205. For simplicity, not every letter of the alphabet is shown, but the other letters could be in alternative embodiments. The navigation alphabet 2205 can be used to quickly navigate to particular contacts. For example, if a user wanted to locate the contact John Wayne, the letter W 2210 in the navigation alphabet may be selected.

The selection bubbles 2215 and 2220 are examples of bubbles that can be used to select particular contacts to invite. For example, the selection bubble 2215 is currently selected and the selection bubble 2220 is not selected. Accordingly, if the user selected an invite button 2225, the contact associated with the selection bubble 2215 would be invited to join. In an alternative embodiment, a GUI similar to the GUI 2200 may be utilized to select individuals for inclusion on a black list.

FIG. 23 is a representation of a GUI 2300 demonstrating a virtual currency page in accordance with an illustrative embodiment. In alternative embodiments, fewer, additional, and/or different components may be displayed on the GUI. The GUI 2300 includes rules and/or guidelines regarding the coins, or virtual currency. A dialog 2305 indicates that the user has 37 coins at this time. An invite friends button 2310 navigates the user to the GUI 2200, for example, to invite more friends and get more coins.

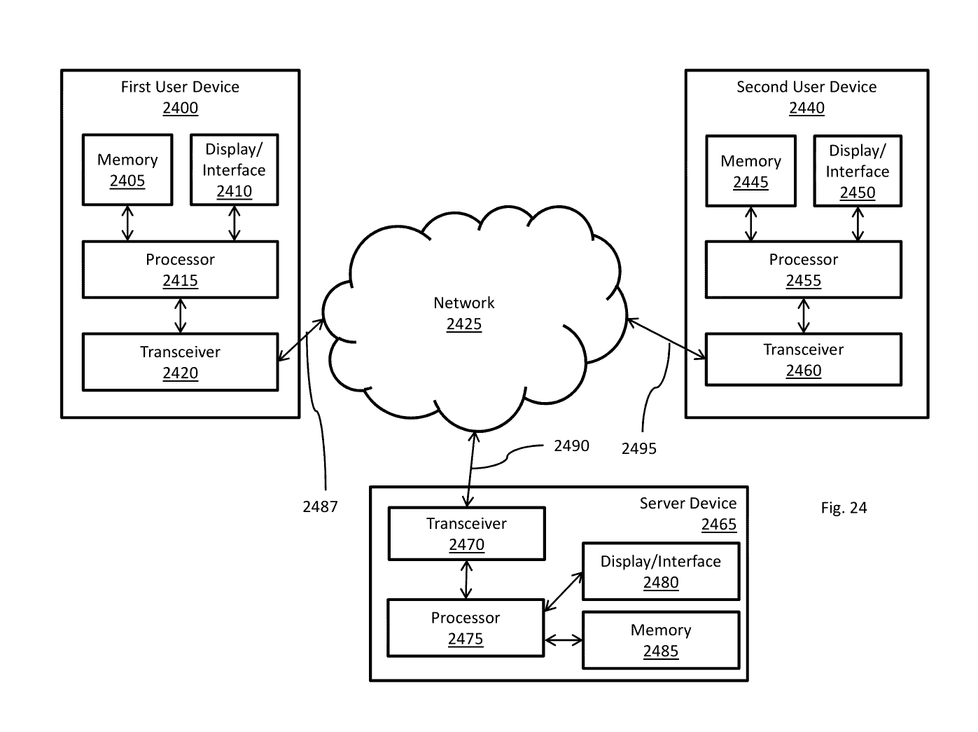

FIG. 24 is a block diagram illustrating various computing and electronic storage devices that may be used in accordance with an illustrative embodiment. In alternative embodiments, fewer, additional, and/or different components may be included in the system. FIG. 24 includes a first user device 2400, a network 2425, a cloud storage system 2430, a second user device 2440, and a server device 2465. The personal computing device 2400 includes a processor 2415 that is coupled to a memory 2405. The first user device 2400 can store and recall data and applications in the memory 2405. The processor 2415 may also display objects, applications, data, etc. on a display/interface 2410. The display/interface 2410 may be a touchscreen, a game system controller, a remote control, a keyboard, a mouse, a trackpad, a microphone, a camera, a set of buttons, a standard electronic display screen, a television, a computer monitor, or any combination of those or similar components. The processor 2415 may also receive inputs from a user through the display/interface 2410. The processor 2415 is also coupled to a transceiver 2420. With this configuration, the processor 2415, and subsequently the personal computing device 2400, can communicate with other devices, such as the second user device 2440 and the server device 2465 through a connection 2487 and the network 2425. Although FIG. 24 shows one first user device 2400, an alternative embodiment may include numerous user devices.

The second user device 2440 includes a processor 2455 that is coupled to a memory 2445. The processor 2455 can store and recall data and applications in the memory 2445. The processor 2455 may also display objects, applications, data, etc. on a display/interface 2450. The display/interface 2450 may have a touchscreen, but may also include or incorporate a keyboard, a game system controller, a remote control, a mouse, a trackpad, a microphone, a camera, a set of buttons, a standard electronic display screen, a television, a computer monitor, or any combination of those or similar components. The processor 2455 may also receive inputs from a user through the display/interface 2450. The processor 2455 is also coupled to a transceiver 2460. With this configuration, the processor 2455, and subsequently the second user device 2440, can communicate with other devices, such as the first user device 2400 through a connection 2495 and the network 2425.

The server device 2465 includes a processor 2475 that is coupled to a memory 2475. The processor 2475 can store and recall data and applications in the memory 2485. The processor 2475 may also display objects, applications, data, etc. on a display/interface 2480. The display/interface 2480 may be a touchscreen, a game system controller, a keyboard, a remote control, a mouse, a trackpad, a microphone, a camera, a set of buttons, a standard electronic display screen, a television, a computer monitor, or any combination of those or similar components. The processor 2475 may also receive inputs from a user through the display/interface 2480. The processor 2475 is also coupled to a transceiver 2470. With this configuration, the processor 2475, and subsequently the viewer electronic device 2465, can communicate with other devices, such as the second user device 2440 through a connection 2490 and the network 2425. Although FIG. 24 shows only server device 2465, an alternative embodiment may include multiple server devices.

The devices shown in the illustrative embodiment may be utilized in various ways. For example, any of the connections 2487, 2490, and 2495 may be varied. Any of the connections 2487, 2490, and 2495 may be a hard wired connection. A hard wired connection may involve connecting the devices through a USB (universal serial bus) port, serial port, parallel port, or other type of wired connection that can facilitate the transfer of data and information between a processor of a device and a second processor of a second device. In another embodiment, any of the connections 2487, 2490, and 2495 may be a dock where one device may plug into another device. While plugged into a dock, the client-device may also have its batteries charged or otherwise be serviced. In other embodiments, any of the connections 2487, 2490, and 2495 may be a wireless connection. These connections may take the form of any sort of wireless connection, including but not limited to Bluetooth connectivity, Wi-Fi connectivity, or another wireless protocol. Other possible modes of wireless communication may include near-field communications, such as passive radio-frequency identification (RFID) and active (RFID) technologies. RFID and similar near-field communications may allow the various devices to communicate in short range when they are placed proximate to one another. In an embodiment using near field communication, two devices may have to physically (or very nearly) come into contact, and one or both of the devices may sense various data such as acceleration, position, orientation, velocity, change in velocity, IP address, and other sensor data. The system can then use the various sensor data to confirm a transmission of data over the internet between the two devices. In yet another embodiment, the devices may connect through an internet (or other network) connection. That is, any of the connections 2487, 2490, and 2495 may represent several different computing devices and network components that allow the various devices to communicate through the internet, either through a hard-wired or wireless connection. Any of the connections 2487, 2490, and 2495 may also be a combination of several modes of connection. The network 2425 may also include similar components described above with respect to the connections 2487, 2490, and 2495. In addition, the network 2425 may include intermediate servers, routing devices, processors, data traffic management services, and wired or un-wired connections.

To operate different embodiments of the system or programs disclosed herein, the various devices may communicate using the software systems and methods disclosed herein. Software applications may be manually installed on the devices or downloaded from the internet. Such software applications may allow the various devices in FIG. 24 to perform some or all of the processes and functions described herein. Additionally, the embodiments disclosed herein are not limited to being performed only on the disclosed devices in FIG. 24. It will be appreciated that many various combinations of computing devices may execute the methods and systems disclosed herein. Examples of such computing devices may include smart phones, personal computers, servers, laptop computers, tablets, blackberries, RFID enabled devices, video game console systems, smart TV devices, or any combinations of these or similar devices.

In one embodiment, a download of a program to the first user device 2400 involves the processor 2415 receiving data through the transceiver 2420 through connection 2487 and the network 2425. The network 2425 may be connected to the internet. The processor 2415 may store the data (like the program) in the memory 2405. The processor 2415 can execute the program at any time. In another embodiment, some aspects of a program may not be downloaded to the server device 2415. For example, the program may be an application that accesses additional data or resources located in a server. In another example, the program may be an internet-based application, where the program is executed by a web browser and stored in a server that is part of the network 2425. In the latter example, temporary files and/or a web browser may be used on the first user device 2400 in order to execute the program, system, application, etc. In additional embodiments, the second user device 2440 and the server device 2465 may use, store, or download software applications and web based programs in a similar way.

The configuration of the first user device 2400, the portable the second user device 2440, the server device 2465, and the network 2425 is merely one physical system on which the disclosed embodiments may be executed. Other configurations of the devices shown exist to practice the disclosed embodiments. Further, configurations of additional or different devices than the ones shown in FIG. 24 may exist to practice the disclosed embodiments. Additionally, the devices shown in FIG. 24 may be combined to allow for fewer devices or separated where more than the three devices shown exist in a system.

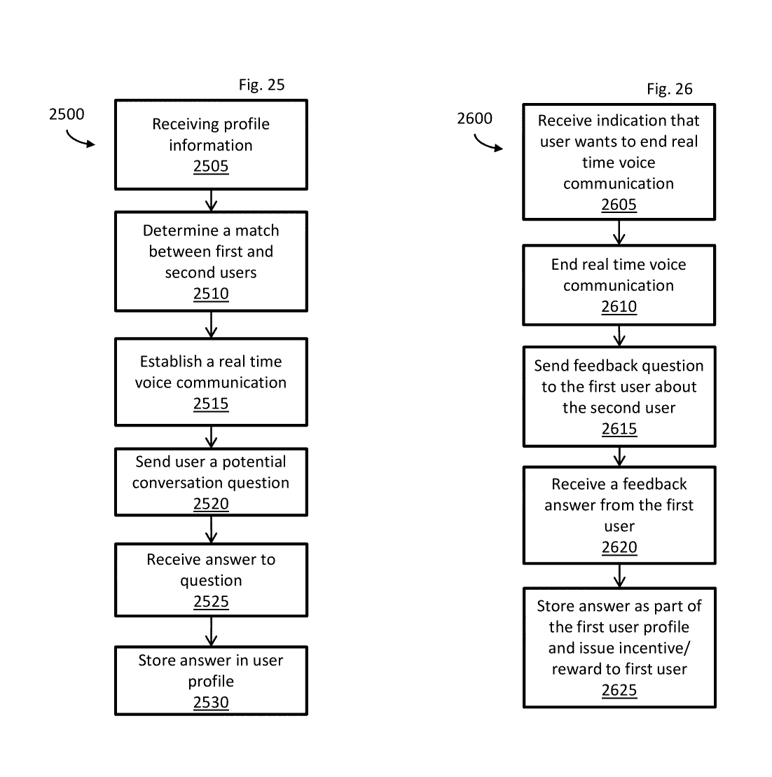

FIG. 25 is a flow diagram 2500 illustrating a method of matching two users for a real time voice communication in accordance with an illustrative embodiment. In alternative embodiments, fewer, additional, and/or different operations may be performed. Also, the use of a flow diagram is not meant to be limiting with respect to the order of operations performed. In an operation 2505, the system receives user-profile information for a first and second user. The user-profile information may include demographic information about the users, call time preference data specified by the users, and user match preference data determined by the users. In an operation 2510, the system determines a match between the first user and the second user based on the first user-profile information and the second user-profile information.

In an operation 2515, the system establishes, in response to the determined match, a real time voice communication over a network (such as a land line phone call, cellular network phone call, or VoIP) between a first user device and a second user device. With regard to the real time voice communication, the first and second user device contact information is not sent to each other. In other words, the first user device does not see or receive the contact information of the second user device, and vice versa. Further, the system may send and/or receive information to the first and second user devices during the real time voice communication. For example, in an operation 2520, a conversation question is sent to the first user device. In an operation 2525, an indication of an answer to the conversation question is received. In an operation 2530, the answer to the conversation question is stored as part of the first-user profile information in order to be used in determining subsequent matches for the second user.

FIG. 26 is a flow diagram 2600 illustrating a method of receiving feedback about a user after a real time voice communication in accordance with an illustrative embodiment. In alternative embodiments, fewer, additional, and/or different operations may be performed. Also, the use of a flow diagram is not meant to be limiting with respect to the order of operations performed. In an operation 2605, the system receives an indication that a first or second user wants to end the real time voice communication.

In an operation 2610, the system ends the real time voice communication. In an operation 2615, the system sends a feedback question about the second user to the first user device. In an operation 2620, the system receives a feedback answer response to the feedback question. In an operation 2625, the system stores the feedback answer as part of the first-user profile information, wherein the feedback answer is configured to be used in determining subsequent matches for the first user. In an alternative embodiment, the feedback answer may additionally or instead be stored in the second user-profile information for determining subsequent matches for the second user.

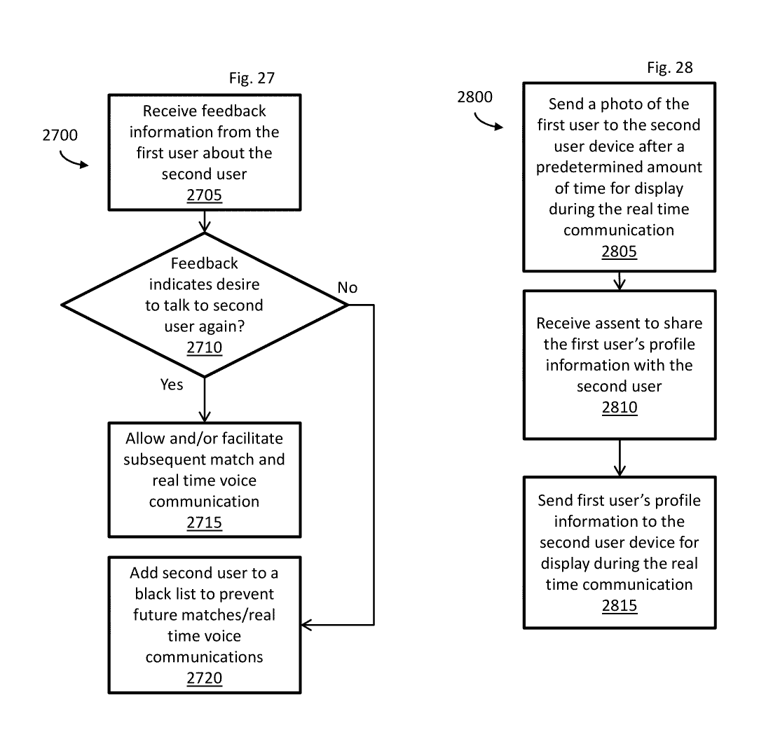

FIG. 27 is a flow diagram 2700 illustrating a method of processing feedback for a black list in accordance with an illustrative embodiment. In alternative embodiments, fewer, additional, and/or different operations may be performed. Also, the use of a flow diagram is not meant to be limiting with respect to the order of operations performed. In an operation 2705, the system receives feedback information from the first user about the second user.

In an operation 2710, the system determines whether the feedback indicates that the first user wants to talk to the second user again. This determination may be implicit based on feedback or may be explicit based on affirmative assent to talk to the second user again. If the first user would not like to have a second real time voice communication (operation 2720) with the second user, the system stores as part of the first user-profile information, the second user on the first user's black list. That is, the first user will not be matched or have a real time voice communication with anyone including the second user that is on the black list. If the first user would like to have the second real time voice communication (operation 2715), the system stores as part of the first user-profile information, an opt-in indication such that the second real time voice communication can be subsequently established.

FIG. 28 is a flow diagram 2800 illustrating a method of releasing user-profile information between users in accordance with an illustrative embodiment. In alternative embodiments, fewer, additional, and/or different operations may be performed. Also, the use of a flow diagram is not meant to be limiting with respect to the order of operations performed. In an operation 2805, the system, after a predetermined amount of time elapses during a real time voice communication, sends a photo of the first user to the second user device. The photo can be displayed on the second user device during the real time communication.

In an operation 2810, the system receives an assent to share user-profile information about the first user with the second user device. In an operation 2815, the system sends the user-profile information about the first user to the second device in response to receiving the assent. The information can be displayed on the second user device on a graphical user interface (GUI).

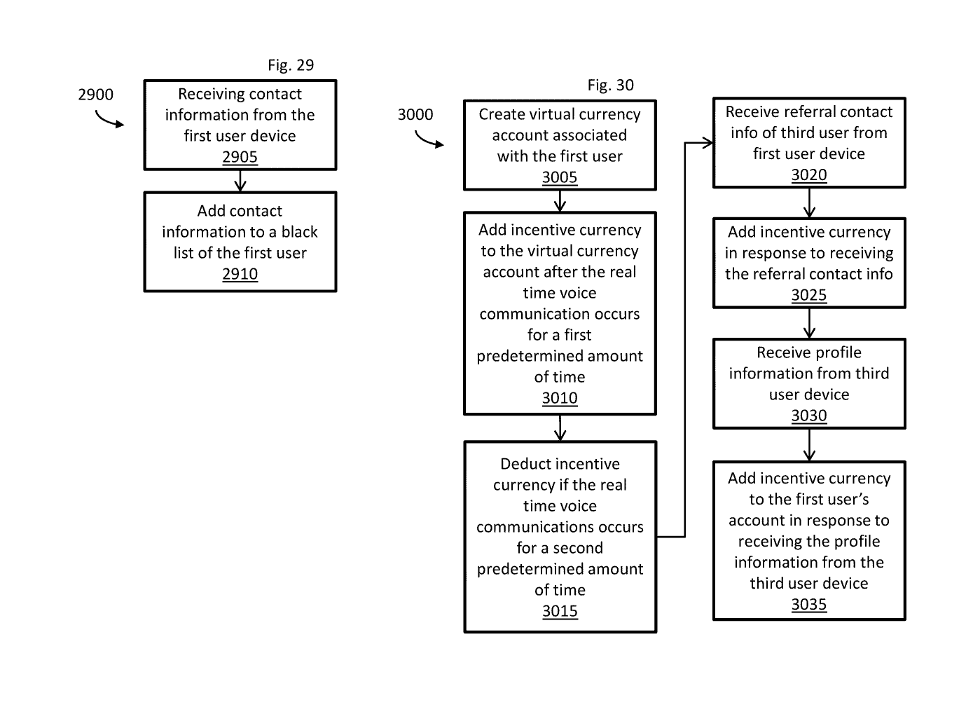

FIG. 29 is a flow diagram 2900 illustrating a method of receiving contact information for a black list in accordance with an illustrative embodiment. In alternative embodiments, fewer, additional, and/or different operations may be performed. Also, the use of a flow diagram is not meant to be limiting with respect to the order of operations performed. In an operation 2905, the system receives contact information of a known contact of the first user device. In an operation 2910, the system adds the contact to a black list of the first user. In this way, the system will never match the known contact with the first user. Furthermore, the system will never establish a real time voice communication between the first user and the known contact device.

FIG. 30 is a flow diagram 3000 illustrating a method of using a virtual currency account in accordance with an illustrative embodiment. In alternative embodiments, fewer, additional, and/or different operations may be performed. Also, the use of a flow diagram is not meant to be limiting with respect to the order of operations performed. In an operation 3005, the system creates a virtual currency account associated with the first user-profile information. The virtual currency account can store virtual currency, also referred to herein as coins, incentive currency, etc.

In an operation 3010, the system adds a first predetermined amount of the incentive currency to the virtual currency account after the real time voice communication occurs for a first predetermined amount of time. For example, if the real time voice communication lasts for three minutes, the system may add the incentive currency to the virtual currency account.

In an operation 3015, the system deducts a second predetermined amount of the incentive currency if the real time voice communication occurs for a second predetermined amount of time. For example, the system may deduct currency as a sort of payment for talking longer, such as deducting one coin for every extra ten minutes after the first three. A deduction may also be taken for punitive purposes. For example, if the real time voice communication lasts less than a minute, the user who ends the call may be deducted a penalty amount for not giving the other user much of a chance.

In an operation 3020, the system receives referral contact information of a third user from the first user device. In an operation 3025, the system adds, in response to receiving the referral contact information, a predetermined amount of currency to the virtual currency account of the first user. In an operation 3030, the system receives the third user's user-profile information from a third user device. That is, the third user has signed up using the app. As a result, the first user is rewarded again. In an operation 3035, the system adds another predetermined amount of the incentive currency to the virtual currency account in response to receiving the third user-profile information.

In another illustrative embodiment, a user may get more virtual or incentive currency by buying it with real currency. For example, the system may receive an authorization to transfer real currency (such as from a bank account or through a credit card company), from an account associated with the first user. In response to the transfer, the system can then add the incentive currency to the virtual currency account.

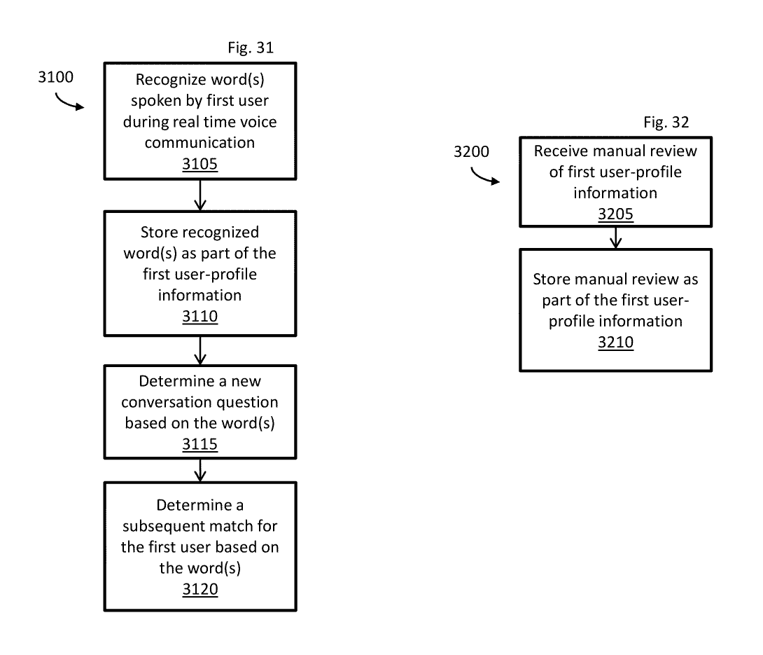

FIG. 31 is a flow diagram 3100 illustrating a method of conversation recognition in accordance with an illustrative embodiment. In alternative embodiments, fewer, additional, and/or different operations may be performed. Also, the use of a flow diagram is not meant to be limiting with respect to the order of operations performed. In an operation 3105, the system recognizes a word or words spoken by a first user during a real time voice communication.

In an operation 3110, the system stores the recognized word or words as a part of the first user-profile information. The stored words can be used to determine subsequent matches for the first user (operation 3120). For example, if the user talks a lot about airplanes, the first user may later be matched with someone who likes flying. In an operation 3115, the stored word or words may also be used to determine a conversation question configured to further facilitate discussion for the ongoing real time voice communication or a subsequent real time voice communication. For example, the system may recognize that a user is talking a lot about pets. As a result, the system may introduce a conversation question directed to an upcoming local dog show.

FIG. 32 is a flow diagram 3200 illustrating a method of manually reviewing a user profile in accordance with an illustrative embodiment. In alternative embodiments, fewer, additional, and/or different operations may be performed. Also, the use of a flow diagram is not meant to be limiting with respect to the order of operations performed. In an operation 3205, the system receives a manual review of at least part of the first user-profile information. For example, a third party that is not a user of the app may review a user's profile information to determine if everything on there is accurate. In an operation 3210, the system stores the manual review as part of the first user-profile information. For example, a quality checker may see that a user has included the term “bodybuilder” in his profile, yet based on his photo is a person that is only in relatively good shape. Accordingly, the quality checker may put a manual review in that the user should not be characterized as a bodybuilder by the system. Similarly, a user-profile can include hidden information. The hidden information may be a manual review, may be data collected during a call such as audio, recognized words, answered questions, ratings about other users, time spent on calls, frequency of calls and/or availability, etc. The hidden information is not displayed to any of the users, but is still attached to the user's profile so that the hidden information can be used to determine matches for a user.

Accordingly, the hidden information may include manual reviews that can review a user's photo, manually assess body type (fitness) of the user (lean, athletic, overweight, etc.) and add the information to the hidden part of a user's profile. Such information can be used by the system for more accurate search and matching for people's preferences.

In an illustrative embodiment, users may pay fees in real currency to use the app. For example, users may pay a five dollars per month for the service. In one embodiment, the users would then get ten free coins per month. Users may also buy coins, for example one coin for $0.25. In another embodiment, currency may be used to send other users gifts. For example, the gifts may be virtual, such as a message with virtual flowers or an email with a talking chimp. A user may buy an online gift card and electronically gift it to another user. A user may buy something online, such as a streaming song or service and send it directly to another user. Anytime a user uses the system to procure or send something from/through a third party, revenue might be generated by the system. The system may also facilitate donations to charities.

In another illustrative embodiment, the system may be used to buy and deliver real products to another user. For example, a first user may wish to send a second user flowers. The first user can pick the flowers and pay for them through the app or a third party website/app linked from the system app. After the flowers are paid for, the system can determine where to have them delivered, since the first user might not necessarily have access to the second user's contact information, including address. Other types of products may also be integrated into the system such as chocolates, coffee, reservations to restaurants, movie theaters, snacks, etc. In one embodiment, the app may also facilitate setting up an in person meeting or date for two users that have talked through the app, such as by helping set up a reservation at a restaurant or helping buy movie tickets.

In another illustrative embodiment, disclosed herein is a computer implemented method for enhancing electronic social communication between users. The method uses prior received data and makes an intelligent computer implemented determination of associating a first to a second user. The method also includes establishing a real time voice connection through a server with a first user and then establishing a connection through said server to a second different user and subsequently said server linking the first and second users to provide an electronic linkage and real time voice communication there between. Further, the method includes using data derived in real time from the electronic linkage to ascertain further attributes of the communications between said users to make determinations of the satisfaction of first and second users of the communication. The determinations may be made by using a hypothesis based upon a degree of satisfaction obtained from said linkage data. The method also includes receiving additional input data from said users in real time via user inputs of said first and second user and using both the additional input data and derived real time data to ascertain whether to continue, not continue, or to proceed at a later time the electronic communication between the users. The method may also include modifying the hypothesis of satisfaction of the electronic communications.

The data being derived in real time may include inputs via an user interface. The degree of satisfaction may be displayed to the users so the users can ascertain empirically the communications are going between the users. The data derived in real time may include biometric data about said users. For example, the data may include heart rate data, how hard an individual presses on an interface screen or button, breathing data, or voice pattern data including volume, frequency, etc. The data may include motion data derived from movement of the user devices. The data derived may also include speech to text, voice recognition, semantic analysis, and/or sentiment analysis of the voice data of the users conversation. The data derived may include language independent voice data of sounds of the user for voice recognition and/or sentiment analysis of the user. The method may also include, during said electronic linkage between users, providing said users desirable information about said users in such a manner that enables the users to better facilitate the interaction between each other to improve the degree of satisfaction of the interaction. The method may also include determining the degree of veracity of the user responses to questions posed by the system using the derived real time data of a component of biometric information received by comparing the biometric information received to a baseline empirical results via a computer implemented algorithm.

In an illustrative embodiment, any of the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method according to a set of instructions stored on a memory of a computing device, the method comprising:
receiving, by a processor of the computing device, first user-profile information associated with a first user and second user-profile information associated with a second user;
determining, by the processor, a match between the first user and the second user based on the first user-profile information and the second user-profile information;
establishing, by the processor, in response to determining the match, a real time voice communication over a network between a first user device and a second user device; and
sending or receiving information to the first user device and the second user device during the real time voice communication, wherein:
first contact information associated with the first user device is not sent to the second user device; and
second contact information associated with the second user device is not sent to the first user device.

2. The method of claim 1, wherein real time voice communication over the network is a voice over internet protocol (VoIP) call.

3. The method of claim 1, wherein the first user-profile information and the second user-profile information used to determine the match comprises:
demographic information about the first user and the second user;
call time preference data specified by the first user and the second user; and
user match preference data determined by the first user and the second user.

4. The method of claim 1, further comprising:
receiving, by the processor, an indication to end the real time voice communication;
terminating, by the processor, the real time voice communication;
sending, by the processor, to the first user device, a feedback question about the second user;
receiving, by the processor, a feedback answer responsive to the feedback question; and
storing, by the processor, the feedback answer as part of the first user-profile information, wherein the feedback answer is configured to be used in determining subsequent matches for the first user.

5. The method of claim 4, further comprising storing, by the processor, the feedback answer as part of the second user-profile information, wherein the feedback answer is configured to be used in determining subsequent matches for the second user.

6. The method of claim 1, further comprising:
receiving, by the processor, an indication to end the real time voice communication;
terminating, by the processor, the real time voice communication;
sending, by the processor, to the first user device, a feedback question; and
receiving, by the processor, a feedback answer indicating whether the first user would like to have a second real time voice communication with the second user, wherein:
responsive to feedback indicating that the first user would not like to have the second real time voice communication with the second user, storing, by the processor as part of the first user-profile information, a second user black list indication such that no subsequent real time voice communications are established between the first user and the second user; and
responsive to feedback indicating that the first user would like to have the second real time voice communication with the second user, storing, by the processor as part of the first user-profile information, an opt-in indication such that the second real time voice communication is subsequently established.

7. The method of claim 1, wherein the information comprises a conversation question, and wherein the method further comprises:
sending, by the processor, the conversation question to the first user device; and
receiving, by the processor, an indication of an answer to the conversation question from the second user device; and
storing, by the processor, the answer to the conversation question as part of the first user-profile information, wherein the feedback answer is configured to be used in determining subsequent matches for the second user.

8. The method of claim 1, wherein the first user-profile information comprises a photo of the first user and demographic information about the user, and further wherein the method comprises:
sending, by the processor, the photo of the first user after a predetermined amount of time elapses during the real time voice communication, wherein the processor is configured to display the photo on a second graphical user interface (GUI) of the second device;
receiving, by the processor, an assent from the first user device to share the demographic information with the second user device; and
sending, by the processor to the second user device in response to receiving the assent, the demographic information about the user to the second user device, wherein the demographic information is configured to be displayed on the second GUI of the second device.

9. The method of claim 1, wherein:
the first user-profile information comprises hidden information and non-hidden information;
the hidden information is not displayed on a first graphical user interface (GUI) of the first device or a second GUI of the second device; and
the match is determined at least in part based on the hidden information.

10. The method of claim 1, further comprising:
receiving, by the processor from the first user device, contact information of known contacts to the first user;
storing, by the processor, the contact information as a black list such that the first user is not matched to the known contacts and further that a real time voice communication is not established between the first user device and a known contact device.

11. An apparatus comprising:
a memory;
a processor operatively coupled to the memory; and
a first set of instructions stored on the memory and configured to be executed by the processor, wherein the processor is configured to:
receive first user-profile information associated with a first user and second user-profile information associated with a second user;
determine a match between the first user and the second user based on the first user-profile information and the second user-profile information;
establish, in response to the determined match, a real time voice communication over a network between a first user device and a second user device; and
send or receive information to the first user device and the second user device during the real time voice communication, wherein:
first contact information associated with the first user device is not sent to the second user device; and
second contact information associated with the second user device is not sent to the first user device.

12. The apparatus of claim 11, wherein the processor is further configured to create a virtual currency account associated with the first user-profile information, wherein the virtual currency account is configured to store incentive currency.

13. The apparatus of claim 12, wherein the processor is further configured to:
add a first predetermined amount of the incentive currency to the virtual currency account after the real time voice communication occurs for a first predetermined amount of time; and
deduct a second predetermined amount of the incentive currency to the virtual currency account after the real time voice communication occurs for a second predetermined amount of time.

14. The apparatus of claim 12, wherein the processor is further configured to:
receive referral contact information from the first user device, wherein the referral contact information comprises contact information of a third user;
add, in response to receiving the referral contact information, a first predetermined amount of the incentive currency to the virtual currency account;
receive third user-profile information from a third user device; and
add, in response to receiving the third user-profile information, a second predetermined amount of the incentive currency to the virtual currency account.

15. The apparatus of claim 12, wherein the processor is further configured to:
receive authorization to transfer of real currency from an account associated with the first user; and
add, in response to the authorization to transfer the real currency, a predetermined amount of the incentive currency to the virtual currency account.

16. A non-transitory computer readable medium having instructions stored thereon that, upon execution by a computing device, cause the computing device to perform operations, wherein the instructions comprise:
instructions to receive, by a processor of the computing device, first user-profile information associated with a first user and second user-profile information associated with a second user;
instructions to determine, by the processor, a match between the first user and the second user based on the first user-profile information and the second user-profile information;
instructions to establish, by the processor, in response to determining the match, a real time voice communication over a network between a first user device and a second user device; and
instructions to send or receive information to the first user device and the second user device during the real time voice communication, wherein:
first contact information associated with the first user device is not sent to the second user device; and
second contact information associated with the second user device is not sent to the first user device.

17. The non-transitory computer readable medium of claim 16, further comprising instructions to recognize, by the processor, a word spoken by the first user during the real time voice communication.

18. The non-transitory computer readable medium of claim 17, further comprising instructions to store the recognized word as part of the first user-profile information, wherein the stored word is configured to be used to determine subsequent matches for the first user.

19. The non-transitory computer readable medium of claim 18, further comprising instructions to determine, by the processor, based on the word, a conversation question configured to facilitate conversation during the real time voice conversation or a subsequent real time voice conversation.

20. The non-transitory computer readable medium of claim 16, further comprising instructions to:
receive, by the processor, a manual review of at least a part of the first user-profile information; and
store, by the processor, the manual review as part of the first user-profile information.
